(19) United States
(12) Patent Application Publication
(10) Pub. No.: US 2010/0061593 A1
(43) Pub. Date: Mar. 11, 2010

(54) Extrapolation system for solar access determination

(76) Inventors: Willard S. MacDonald, Bolinas, CA (US); Mark B. Galli, Windsor, CA (US)

Correspondence Address: Willard S. MacDonald, 825 Olema-Bolinas Road, Bolinas, CA, 94924, US

(21) Appl. No.: 12/231,738

(22) Filed: Sep. 5, 2008

(51) Int. Cl. G06K 9/64

(52) U.S. Cl. 382/103

(57) ABSTRACT

An extrapolation system includes acquiring a first orientation-referenced image at a first position, acquiring a second orientation-referenced image at a second position having a vertical offset from the first position, and processing the first orientation-referenced image and the second orientation-referenced image to provide an output parameter extrapolated to a third position that has an offset from the first position and the second position.

### CROSS-REFERENCE TO RELATED APPLICATIONS

N/A.

### BACKGROUND OF THE INVENTION

Solar access refers to the characterization of solar radiation exposure at a designated location. Solar access accounts for daily and seasonal variations in solar radiation exposure that may result from changes in atmospheric clearness, shading by obstructions, or variations in incidence angles of the solar radiation due to the relative motion between the Sun and the Earth. Prior art measurement systems for characterizing solar access typically enable solar access to be determined only at the locations where the measurement systems are positioned. As a result, these measurement systems are not well suited for determining solar access at locations that are inaccessible or remote from the measurement systems, which may be a disadvantage in a variety of contexts.

For example, determining solar access at an installation site of a solar energy system prior to installing the solar energy system may provide the advantage of enabling solar panels within the solar energy system to be positioned and/or oriented to maximize the capture of solar radiation. However, due to space constraints, or in order to minimize shading by obstructions that reduce solar radiation exposure, installation sites of solar energy systems are typically relegated to rooftops or other remote locations. Determining solar access at these installation sites relies on positioning a prior art solar access measurement system on the rooftop or other remote location, which may be a time-consuming, inconvenient, or unsafe task.

In another example, determining solar access of a proposed installation site of a solar energy system in the design phase of a building may provide the advantage of enabling the proposed installation site to be moved at low cost, prior to construction of the building, in the event that the solar radiation exposure at the originally proposed installation site were determined to be inadequate. However, the prior art solar access measurement systems are unsuitable for determining solar access in the building's design phase when the installation sites are not yet accessible to accommodate positioning of the solar access measurement system.

Determining solar access at various positions on a proposed building may also be advantageous to establish the placement of windows, air vents and other building elements. However, prior art solar access measurement systems are also of little use in this context, where the locations of these building elements are typically not accessible for placement of the measurement systems.

A technique disclosed in a website having the URL “http://www.solarpathfinder.com/formulas.html?id=LIDxqaCI” estimates shading by obstructions at a location that is different from where a solar access measurement system is positioned. However, this technique applies only to a location that has a vertical offset from where the solar access measurement system is positioned. In addition, this technique relies on measuring the distance to the obstructions that cause the shading, which may be time-consuming or impractical, depending on the physical attributes of the terrain that contains the obstructions.

In view of the above, there is a need for improved capability to determine solar access at one or more locations that are remote from where a solar access measurement system is positioned.

### BRIEF DESCRIPTION OF THE DRAWINGS

The embodiments of the present invention may be better understood from the following detailed description when read with reference to the accompanying Figures. The features in the Figures are not necessarily to scale. Emphasis is instead placed upon illustrating the principles and elements of the embodiments of the present invention. Wherever practical, like reference designators in the Figures refer to like features.

FIG. 1 shows an example of a flow diagram of an extrapolation system according to embodiments of the present invention.

FIG. 2 shows an example physical context for application of the extrapolation system according to embodiments of the present invention.

FIG. 3 shows one example of a measurement system suitable for implementing the extrapolation system according to embodiments of the present invention.

FIG. 4A shows an example of an orientation-referenced image acquired at a first position according to the flow diagram of FIG. 1.

FIG. 4B shows an example of an orientation-referenced image acquired at a second position according to the flow diagram of FIG. 1.

FIG. 4C shows an example of detected skylines at the first position and the second position based on the acquired images of FIGS. 4A-4B, respectively, and a detected skyline extrapolated to a third position according to embodiments of the present invention.

FIG. 4D shows an example of the detected skyline extrapolated to the third position as shown in FIG. 4C, according to embodiments of the present invention.

FIG. 4E shows an example of the detected skyline extrapolated to the third position as shown in FIG. 4C, with an overlay of paths traversed by the Sun on daily and monthly timescales, according to embodiments of the present invention.

FIGS. 5A-5C show simplified views of the example physical context shown in FIG. 2.

### DETAILED DESCRIPTION

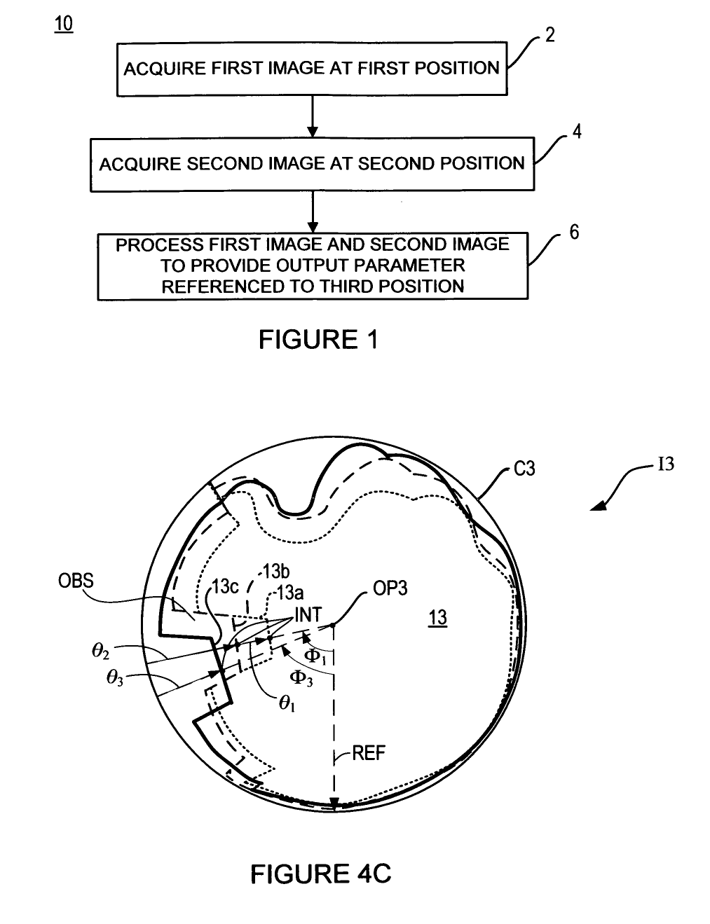

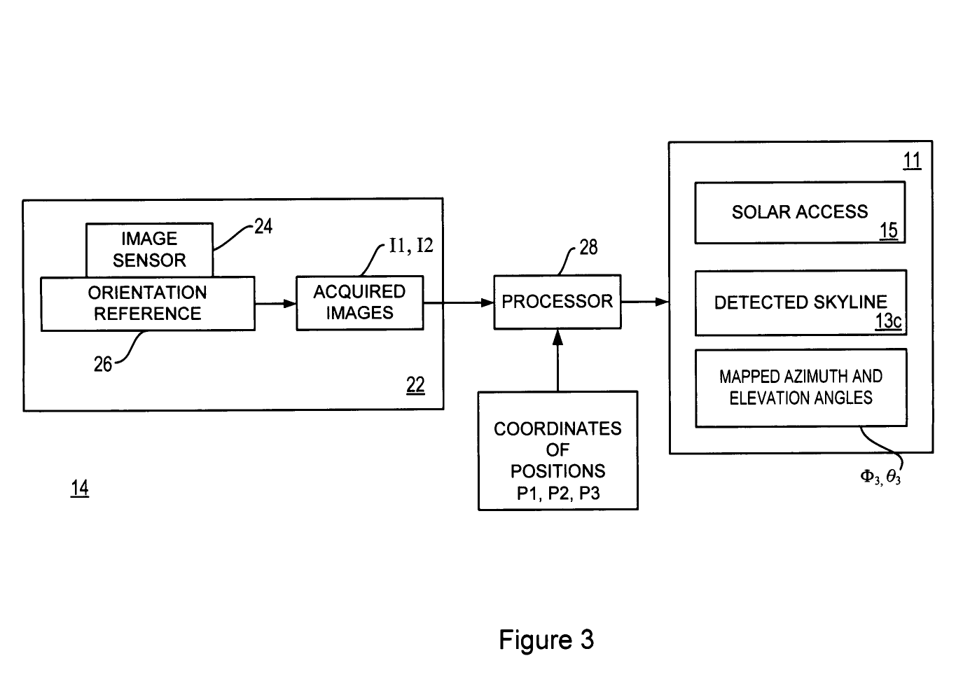

FIG. 1 shows a flow diagram of an extrapolation system 10 according to embodiments of the present invention. The extrapolation system 10 includes acquiring an orientation-referenced image (hereinafter “image I1”) at a first position P1 (step 2), acquiring an orientation referenced image (hereinafter “image I2”) at a second position P2 (step 4), and processing the image I1 acquired at the first position P1 and the image I2 acquired at the second position P2 to provide a detected skyline 13c, a set of azimuth and elevation angles Φ₃, θ₃, a determination of solar access 15, or other output parameter 11 (shown in FIG. 3) extrapolated to a third position P3 that is offset from the first position P1 and the second position P2 (step 6).

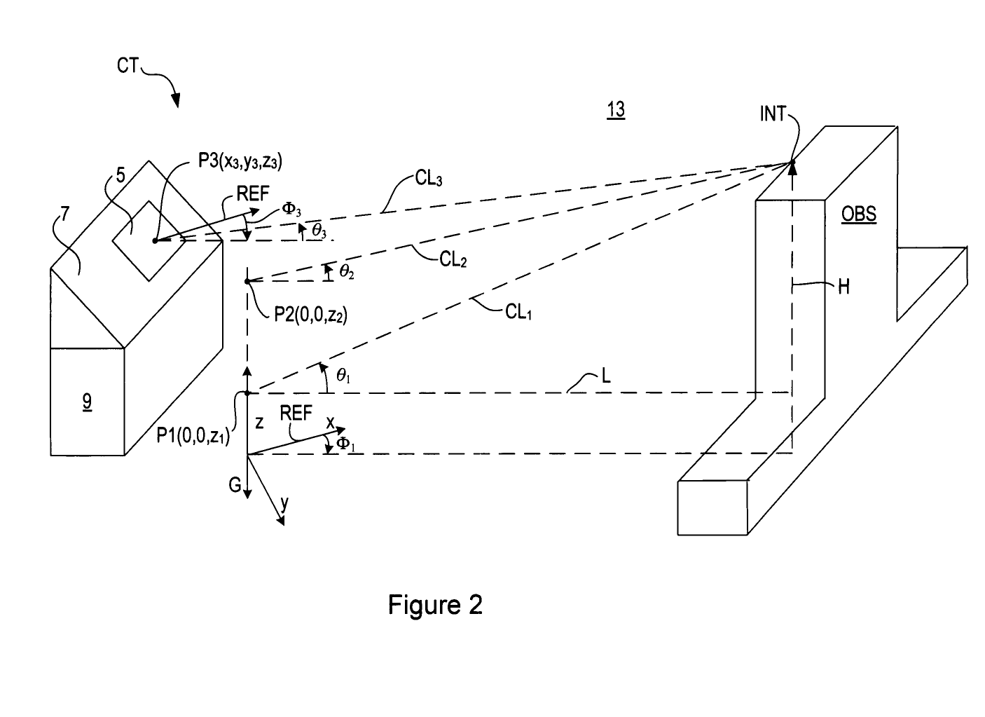

FIG. 2 shows an example physical context CT for application of the extrapolation system 10 according to embodiments of the present invention. In FIG. 2, the third position P3 is shown at a proposed installation site 5 for a solar energy system (not shown) on a roof 7 of a building 9. An example of an obstruction OBS is also shown in the relevant skyline of the proposed installation site 5. The obstruction OBS may include buildings, trees, or other features that form a natural or artificial horizon within the relevant skyline that may limit or otherwise influence the solar radiation exposure at the positions P1, P2, P3. The obstruction OBS impinges the open sky 13 at an interface INT. The reference element “INT” designates one or more positions along the interface between the open sky 13 and each of one or more obstructions OBS in the relevant skyline. Geometric construction lines CL₁, CL₂, CL₃ from each of the positions P1, P2, P3, respectively, to one example position on the interface, hereinafter “interface INT”, elevation angles θ₁, θ₂, θ₃, azimuth angles Φ₁, Φ₃ relative to a heading reference REF, and corresponding height H, and distance L are indicated in the example physical context CT to show geometric aspects that are relevant to the extrapolation system 10.

In this example, the position P1 has coordinates (0, 0, z₁) and the position P2 has coordinates (0, 0, z₂) along corresponding axes in a Cartesian x, y, z coordinate system, indicating that there is an offset in the vertical, or “z” direction between the position P1 and the position P2. The z axis, in this example, has a direction that is anti-parallel to the Earth's gravity vector G. The position P3 has coordinates (x₃, y₃, z₃), indicating that in this example physical context CT, the position P3 has an offset from the position P1 and the position P2 in each of the “x” direction, the “y” direction and the “z” direction. In alternative examples, the position P3 is offset or remote from the positions P1, P2 in only one or two of the “x”, “y”, and “z” directions.

The geometric construction line CL₁ between the position P1 and the interface INT has an azimuth angle Φ₁, based on projection of the construction line CL₁ into the plane z=z₁ (not shown). Due to the vertical or “z” direction offset between the position P1 and the position P2, the geometric construction line CL₂ between the position P2 and the interface INT also has the azimuth angle Φ₁ based on projection of the construction line CL₂ into the plane z=z₁. The construction line CL₁ has an elevation angle θ₁ relative to a plane z=z₁, whereas the construction line CL₂ has an elevation angle θ₂ relative to a plane z=z₂ (not shown). The geometric construction line CL₃ between the position P3 and the interface INT has an azimuth angle Φ₃ based on projection of the construction line CL₃ into the plane z=z₃ (not shown). Typically, the azimuth angle Φ₃ is different from the azimuth angle Φ₁. The construction line CL₃ has a third elevation angle θ₃ relative to a plane z=z₃. In the example physical context CT, the position P1 is a distance L from the interface INT, in the direction of the azimuth angle Φ₁, as indicated by projection of the construction line CL₁ into the plane z=z₁. The interface INT has a height H from the plane z=0.

FIG. 3 shows one example of a measurement system 14 suitable for acquiring the images I1, I2, for processing the images I1, I2, and for implementing various aspects of the extrapolation system 10 included in steps 2-6 (shown in FIG. 1). The measurement system 14 typically includes a skyline imaging system 22 having an image sensor 24 and an orientation reference 26 suitable for acquiring the orientation-referenced images I1, I2 of the relevant skyline that is in the field of view of the image sensor 24. The image sensor 24 is coupled to, or is in signal communication with, the orientation reference 26, which enables the images I1, I2 provided by the image sensor 24 to be referenced to the Earth's gravity vector G or to any other suitable level reference, and/or to the Earth's magnetic vector or other suitable heading reference REF. The orientation reference 26 typically includes a mechanical or electronic level, an electromagnetic level, a tilt sensor, a two-dimensional gimbal or other self-leveling system, or any other device, element, or system suitable to provide a level reference for the relevant skylines captured in the images I1, I2. The orientation reference 26 may also include a magnetic compass, an electronic compass, a magneto-sensor or other type of device, element, or system that enables images I1, 12 provided by the image sensor 24 to be referenced to the Earth's magnetic vector, or other designated azimuth or heading reference REF, at the positions P1, P2 where the images I1, I2, respectively, are acquired. Alternatively, when the Sun is visible within the field of view of the skyline imaging system 22 at a known date and time, a level reference for the images I1, I2 may be established using known techniques based on the longitude and latitude of the positions P1, P2 and a known heading orientation of the skyline imaging system 22. When the Sun is visible within the field of view of the skyline imaging system 22 at a know date and time, a heading reference for the images I1, I2, may be established using know techniques based on the longitude and latitude of the positions P1, P2, and a known level orientation of the skyline imaging system 22.

According to one embodiment of the extrapolation system 10, step 2 includes positioning the measurement system 14 at the position P1, where the skyline imaging system 22 then acquires the orientation-referenced image I1. Step 4 includes positioning the measurement system 14 at the position P2, where the skyline imaging system 22 then acquires the orientation-referenced image I2. The images I1, I2 acquired by the skyline imaging system 22 according to steps 2 and 4 of the extrapolation system 10 are typically provided to a processor 28 that is enabled to provide the output parameter 11 according to step 6 of the extrapolation system 10 (shown in FIG. 1).

The SOLMETRIC SUNEYE, a commercially available product from SOLMETRIC Corporation of Bolinas, Calif., USA provides one example of a hardware and software context suitable for implementing various aspects of the measurement system 14. The SOLMETRIC SUNEYE includes a skyline imaging system 22 that is enabled to provide the orientation-referenced images I1, I2 of the relevant skylines at the positions P1, P2, respectively. Points within the orientation-referenced image I1 provided by the SOLMETRIC SUNEYE have mappings to a first set of azimuth angles and elevation angles. Points within the orientation-referenced image I2 provided by the SOLMETRIC SUNEYE have mappings to a second set of azimuth angles and elevation angles. Each of the sets of azimuth angles and elevation angles are typically established through calibration of the field of view of the skyline imaging system 22.

The calibration typically includes placing the SOLMETRIC SUNEYE at a designated physical location, with a designated reference heading and a level orientation. The calibration then includes capturing a calibration image that includes one or more physical reference positions that are each at a predetermined azimuth angle and elevation angle in the field of view of the skyline imaging system 22. From the predetermined azimuth angles and elevation angles of the one or more physical reference positions in the calibration image, other points in the field of view of the skyline imaging system 22 may be mapped to corresponding azimuth angles and elevation angles using look-up tables, curve fitting or other suitable techniques. The calibration used in the SOLMETRIC SUNEYE typically accommodates for image distortion, aberrations, or other anomalies in the field of view of the skyline imaging system 22 of the SOLMETRIC SUNEYE.

In one example implementation of steps 2 and 4 of the extrapolation system 10, the SOLMETRIC SUNEYE acquires the images I1, I2 with an image sensor 24 that includes a digital camera and a fisheye lens or other wide field of view lens that are integrated into a skyline imaging system 22 of the SOLMETRIC SUNEYE. The digital camera and the fisheye lens have a hemispherical field of view suitable for providing digital images that represent the relevant skyline at each of the positions P1, P2. The images I1, I2 that are provided by the SOLMETRIC SUNEYE each have a level orientation, and a heading orientation (typically south-facing in the Earth's northern hemisphere, and north-facing in the Earth's southern hemisphere) when each of the images I1, I2 is acquired. As a result of the calibration of the field of view of the skyline imaging system 22 of the SOLMETRIC SUNEYE, each point in the resulting image I1 has a corresponding pair of referenced azimuth angles and elevation angles associated with it. Similarly, each point in the resulting image I2 also has a corresponding pair of referenced azimuth angles and elevation angles associated with it. Each point in the field of view of the skyline imaging system 22 may be represented by a portion of a pixel, or by a group of one or more pixels in the digital images that represent the relevant skylines captured in the images I1, I2.

Other examples of commercially available products that may be used to implement various aspects of the measurement system 14 acquire the image I1 by first projecting a first corresponding image of the relevant skyline on a reflective or partially reflective contoured surface at the position P1. These commercially available products then capture a first digital image of the first corresponding image that is projected on the contoured surface. The image I2 is acquired by first projecting a second corresponding image of the relevant skyline on a reflective or partially reflective contoured surface at the position P2. These commercially available products then capture a second digital image of the second corresponding image that is projected on the contoured surface. Each of the resulting first and second digital images typically represents a hemispherical or other-shaped field of view suitable for establishing the images I1, I2 of the relevant skylines at each of the positions P1, P2, respectively. The images I1, I2 provided by these types of measurement systems 14 each have a level orientation or level reference, and/or a heading orientation or a heading reference (typically south-facing in the Earth's northern hemisphere, and north-facing in the Earth's southern hemisphere) when each of the first and second digital images is captured. Accordingly, as a result of calibration of this type of measurement system 14, each point in the resulting image I1 has a corresponding pair of referenced azimuth and elevation angles associated with it, and each point in the resulting image I2 has a corresponding pair of referenced azimuth and elevation angles associated with it. Typical calibration schemes for these types of measurement systems 14 include establishing one or more scale factors and/or rotational corrections for the captured digital images, typically based on the relative positions of physical features present in the captured digital images and then applying the scale factors and/or rotational corrections so that points in each of the first and second digital images may be mapped to corresponding azimuth angles and elevation angles.

The image sensor 24 in the skyline imaging system 22 of the measurement system 14 may also acquire each of the images I1, I2, based on one or more sectors or other subsets of a hemispherical, or other-shaped field of view at each of the positions P1, P2, respectively. To achieve a resulting field of view of the relevant skyline in each of the images I1, I2 that is sufficiently wide to establish the output parameter 11, the one or more sectors or other subsets acquired by the image sensor 24 in the skyline imaging system 22 may be digitally “stitched” together using know techniques. One example of a skyline imaging system 22 that is suitable for establishing each of the images I1, I2 based on multiple sectors is provided by M. K. Dennis, An Automated Solar Shading Calculator, Proceedings of Australian and New Zealand Solar Energy Society, 2002.

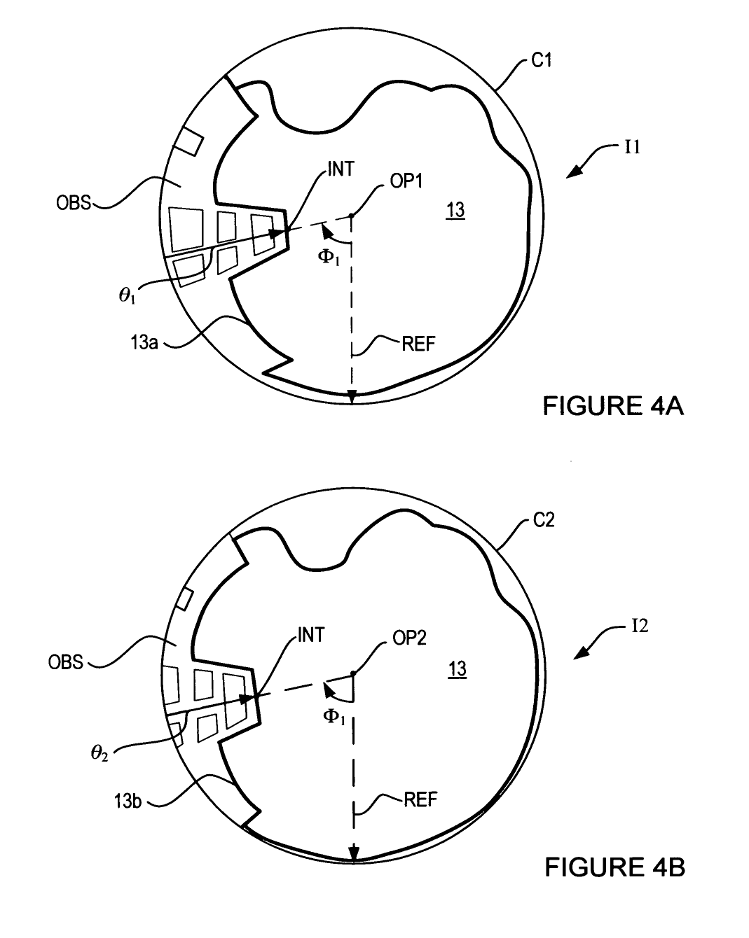

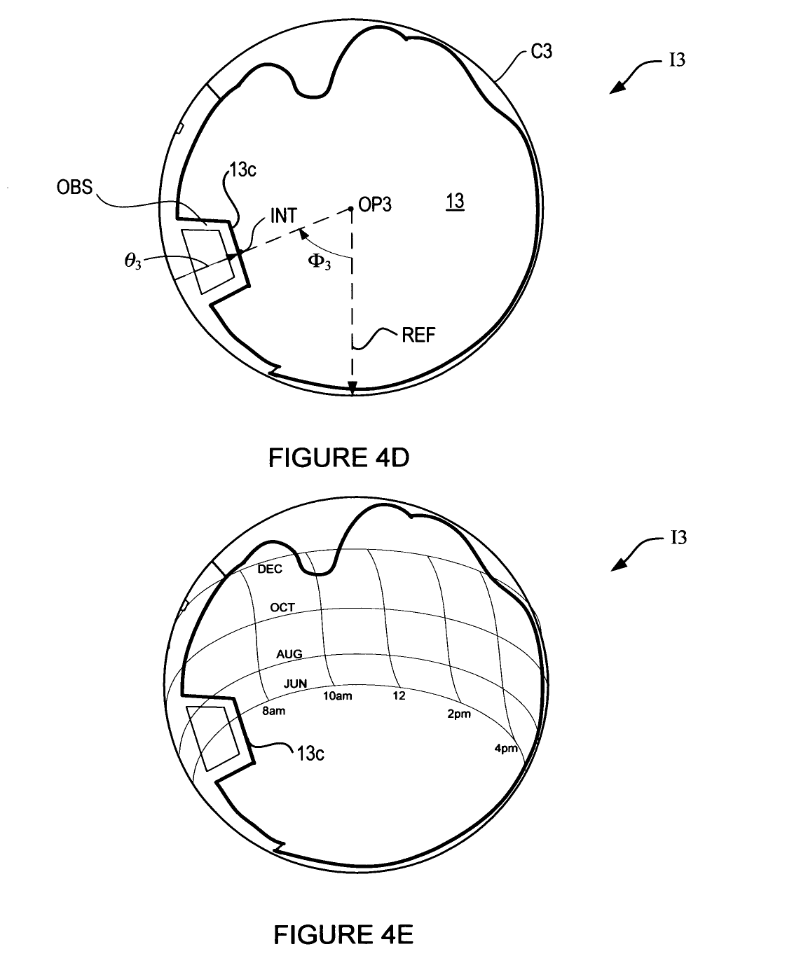

FIG. 4A shows one example of an image I1 acquired at the position P1. In this example, the image I1 represents a hemispherical view of the relevant skyline, referenced to the position P1. The hemispherical view in this example is acquired by a digital camera having a fisheye lens with an optical axis aligned with the z axis (shown in FIG. 2). While the fisheye lens in this example has a field of view of one hundred eighty degrees, in alternative examples, the fisheye lens may have a different field of view that is sufficiently wide to capture a portion of the relevant skyline substantial enough to establish the output parameter 11 that is designated in step 6 of the extrapolation system 10. Multiple points on the interface INT between each obstruction OBS included in the relevant skyline and the open sky 13 of the image I1 cumulatively define a detected skyline 13a that is shown superimposed on the image I1.

Points within the image I1 have a mapping to corresponding azimuth angles and elevation angles, so that each point on the detected skyline 13a in the image I1 has an associated azimuth angle and elevation angle. For the purpose of illustration, the azimuth angle to an example point on the interface INT within the image I1 is indicated by the reference element Φ₁ and the elevation angle to the example point on the interface INT within the image I1 is indicated by the reference element θ₁. Azimuth angles are indicated relative to an axis defining the heading reference REF. The elevation angle θ₁ to the point on the interface INT at the azimuth angle Φ₁ is represented by the radial distance from a circumference C1 to the interface INT toward the origin OP1 of the image I1. In this example, the origin OP1 in the image I1 corresponds to the position P1 in the physical context CT of FIG. 2. The origin OP1 of the image I1 has a mapping to an elevation angle of 90 degrees in the image I1, and in the example where the image sensor 24 has a field of view of one hundred eighty degrees, the circumference C1 of the image I1 has a mapping to an elevation angle of 0 degrees in the image I1. The circumference C1 of the image I1 typically corresponds to the plane z=z₁ in the physical context CT of FIG. 2. Radial distances between the circumference C1 and the origin OP1 have a mapping to elevation angles that are between 0 and 90 degrees, where the mapping to elevation angles at designated azimuth angles is typically established through the calibration of the skyline imaging system 22 of the measurement system 14 that is used to acquire the image I1.

FIG. 4B shows one example of an image I2 acquired at the position P2. In this example, the image I2 represents a hemispherical view of the relevant skyline, referenced to the position P2. The image I2 typically includes buildings, trees or the other obstructions OBS that are also present in the image I1. In this example, the image I2 is also acquired by the digital camera having the fisheye lens with a field of view of one hundred eighty degrees and the optical axis aligned with the z axis. Multiple points on the interface INT between each obstruction OBS included in the relevant skyline and the open sky 13 of the image I2 cumulatively define a detected skyline 13b that is shown superimposed on the image I2.

Points within the image I2 have a mapping to corresponding azimuth angles and elevation angles, so that each point on the detected skyline 13b in the image I2 has an associated azimuth angle and elevation angle. For the purpose of illustration, the azimuth angle to the example point on the interface INT within the image I2 is indicated by the reference element Φ₁ and the elevation angle to the example point on the interface INT within the image I2 is indicated by the reference element θ₂. Azimuth angles are also indicated relative to the axis defining the heading reference REF. The elevation angle θ₂ to the point on the interface INT at the azimuth angle Φ₁ is represented by the radial distance from a circumference C2 to the interface INT toward an origin OP2 in the image I2. In this example, the origin OP2 corresponds to the position P2 in the physical context CT of FIG. 2. The origin OP2 of the image I2 has a mapping to an elevation angle of 90 degrees in the image I2, and in the example where the image sensor 24 has a field of view of one hundred eighty degrees, the circumference C2 of the image I2 maps to an elevation angle of 0 degrees in the image I2. The circumference C2 of the image I2 typically corresponds to the plane z=z₂ in the physical context CT of FIG. 2. Radial distances between the circumference C2 and the origin OP2 have a mapping to elevation angles that are between 0 and 90 degrees, where the mapping to elevation angles at designated azimuth angles is typically established through the calibration of the skyline imaging system 22 of the measurement system 14 that is used to acquire the image I2.

The SOLMETRIC SUNEYE is enabled to automatically provide a detected skyline 13a, 13b for each of the images I1, I2, respectively, that are acquired by the SOLMETRIC SUNEYE. HOME POWER magazine, ISSN1050-2416, October/November 2007, Issue 121, pages 88-90, herein incorporated by reference, shows an example wherein processing of an acquired image by the SOLMETRIC SUNEYE provides enhanced contrast between open sky 13 and obstructions OBS in the relevant skyline, which is used to automatically define multiple points on the interface INT that form a detected skyline. The SOLMETRIC SUNEYE also provides for manual correction, enhancement, or modification to the automatically detected skyline by a user of the SOLMETRIC SUNEYE. The detected skylines provided by the SOLMETRIC SUNEYE are suitable for establishing the detected skylines 13a, 13b within each of the images I1, I2, respectively, that are acquired by the SOLMETRIC SUNEYE. Measurement systems 14, such as those disclosed by M. K. Dennis, An Automated Solar Shading Calculator, Proceedings of Australian and New Zealand Solar Energy Society, 2002, typically include processes or algorithms to distinguish between the open sky 13 and obstructions OBS, and are suitable for computing, detecting or otherwise establishing the detected skyline 13a, 13b from the images I1, I2, respectively, that are acquired by the skyline imaging system 22 within the measurement systems 14.

Measurement systems 14 that rely on projecting images of the relevant skyline onto a contoured surface may provide for manual designation of the detected skylines 13a, 13b within the corresponding images that are projected onto a contoured surface. These measurement systems 14 may alternatively provide for user-entered designations or other manipulations of subsequent digital images that are captured of the projected images, and are suitable for computing, detecting or otherwise establishing the detected skyline 13a, 13b from the images I1, I2, respectively, that are acquired by the skyline imaging system 22 within the measurement systems 14.

FIG. 4C shows an example wherein the output parameter 11 extrapolated to the position P3 in step 6 of the extrapolation system 10 includes a detected skyline 13c that is referenced to the position P3. The detected skyline 13c in this example is shown superimposed with detected skylines 13a, 13b in a field of view I3. In alternative examples, the detected skyline 13c is presented in the absence of the detected skylines 13a, 13b as shown in FIG. 4D. FIG. 4E shows an example wherein the output parameter 11 extrapolated to the position P3 includes the detected skyline 13c and an overlay of paths that the Sun traverses relative the position P3 on daily and monthly timescales.

The field of view I3 in the examples of FIG. 4C-4E has a hemispherical shape, and has an origin OP3 that corresponds to the position P3 in the physical context CT of FIG. 2. Accordingly, the field of view I3 is referenced to the position P3, which based on the coordinates of the positions P1, P2, P3, is offset by known or otherwise determined distances from the positions P1, P2 at which the images I1, I2, respectively, are acquired. The vertical, or “z” direction, offset between the position P1 and the position P2, causes a point on the detected skyline 13b having the same azimuth angle as a point on the detected skyline 13a to have a different elevation angle on the detected skyline 13b than on the detected skyline 13a, as shown in FIG. 4C. For example, at the azimuth angle Φ₁, the example point on the interface INT on the detected skyline 13a has an elevation θ₁ when referenced to the position P1, whereas the corresponding point on the interface INT on the detected skyline 13b has an elevation angle θ₂ when referenced to the position P2. These different elevation angles, available from the mapping of points in each of the images I1, I2 to corresponding elevation angles and azimuth angles, are indicated in FIG. 4C by the different radial distances from a circumference C3 to the points on the interface INT toward the origin OP3 in the field of view I3.

Each point on the interface INT on the detected skyline 13c of FIG. 4C has a corresponding pair of azimuth and elevation angles. A horizontal offset, indicated by a difference in x and/or y coordinates between the position P3 and the positions P1, P2, typically causes points on the detected skyline 13c, which are referenced to the position P3, to have different azimuth angles from the corresponding points on the detected skylines 13a, 13b. For example, when referenced to the position P3, the point on the interface INT on the detected skyline 13c has an azimuth angle Φ₃, relative to the axis REF, whereas the point on the interface INT on the detected skylines 13a, 13b each have the azimuth angle Φ₁ relative to the axis REF. A vertical offset, indicated by a difference in “z” coordinates between the position P3 and each of the positions P1, P2, causes each point on the detected skyline 13c to have a different elevation angle from a corresponding point on the detected skylines 13a, 13b. For example, when referenced to the position P3, the point on the interface INT on the detected skyline 13c has an elevation angle θ₃, whereas the point on the interface INT on the detected skyline 13a has an elevation angle θ₁ when referenced to the position P1, and the point on the interface INT on the detected skyline 13b has an elevation angle θ₂ when referenced to the position P2.

In the field of view I3, the origin OP3 has a mapping to an elevation angle of 90 degrees, and the circumference C3 has a mapping to an elevation angle of 0 degrees. In the example where the image sensor 24 has a field of view of one hundred eighty degrees, the circumference C3 corresponds to the plane z=z₃ shown in the physical context CT of FIG. 2. Radial distances between the circumference C3 and the origin OP3 map to elevation angles that are between 0 and 90 degrees, where the mapping to elevation angles at designated azimuth angles is typically established through the calibration of the skyline imaging system 22 of the measurement system 14.

FIGS. 4C-4D show examples wherein the output parameter 11 includes a detected skyline 13c that is extrapolated to the position P3, and a mapping of points present in both of the images I1, I2, acquired at the positions P1, P2, respectively, to corresponding points in a relevant skyline that is referenced to the position P3. The points in the relevant skyline that are referenced to the position P3 are represented in the field of view I3 and each have a mapping to corresponding azimuth angles Φ₃ and elevation angles θ₃ established in step 6 of the extrapolation system 10 according to one embodiment of the present invention. These output parameters 11 provided in step 6 of the extrapolation system 10 typically involve a determination of geometric measures, such as the height H of the point on the interface INT and the distance L to the point on the interface INT, that are established based on processing the acquired images I1, I2.

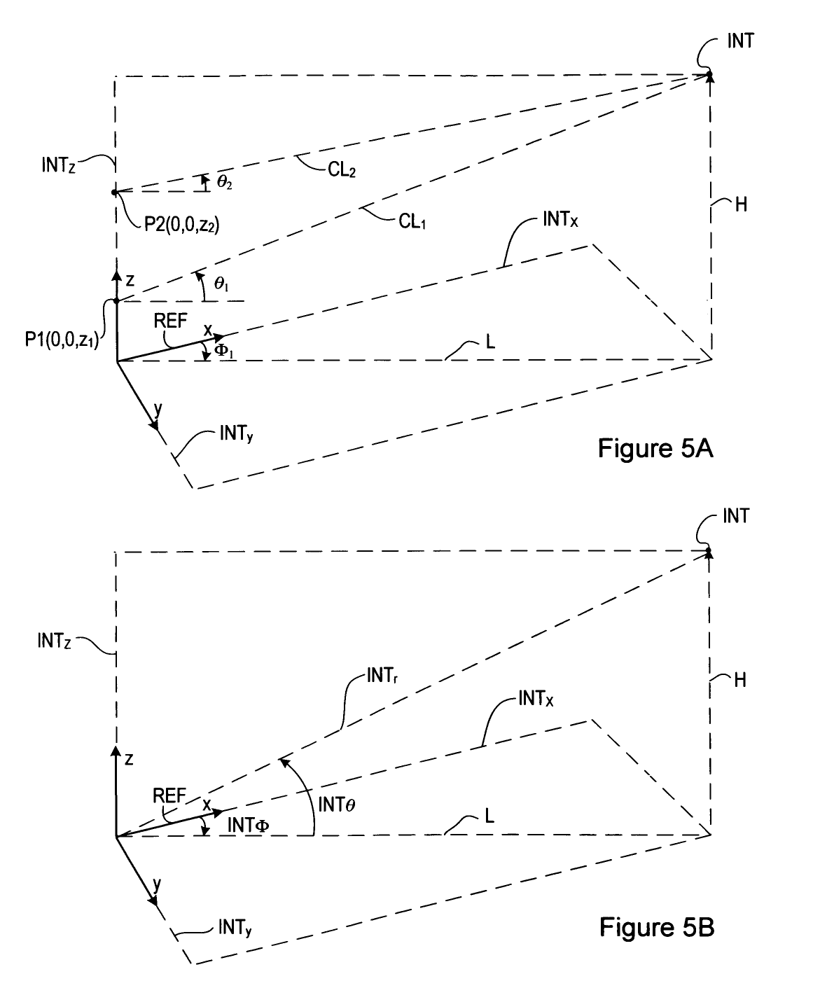

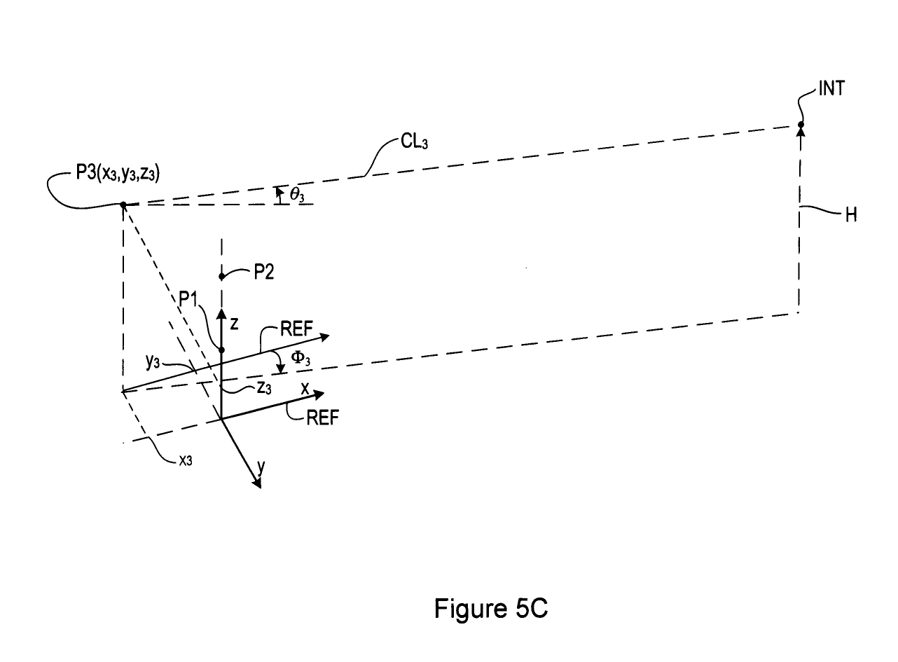

FIGS. 5A-5C show simplified views of the physical context CT, shown in FIG. 2, that are relevant to the processing performed in step 6 of the extrapolation system 10.

FIG. 5A shows a simplified view of elements of the physical context CT, indicating the positions P1, P2, the azimuth angle Φ₁, and the elevation angles θ₁, θ₂, the height H of the point on the interface INT, and the distance L to the point on the interface INT. The height H and the distance L at the azimuth angle Φ₁ may be determined from these elements according to equations (1) and (2), respectively:

H=L tan(θ₁)+z₁ (1)

L=(z₂−z₁)/ (tan (θ₁)−tan (θ₂)) (2)

In equations (1) and (2), the elevation angles θ₁, θ₂, at each azimuth angle Φ₁, are extracted from the images I1, I2, based on the mapping of points in each of the images I1, I2 to corresponding azimuth angles and elevation angles. The coordinates z₁ and z₂ associated with the positions P1, P2, respectively, have been previously designated in the example physical context CT shown in FIG. 2.

FIG. 5B indicates spherical coordinates (INTᵣ, INT_{θ}, INT_{Φ}) and Cartesian coordinates (INTₓ, INT_{y}, INT_{z}) of the point on the interface INT shown in the physical context CT of FIG. 2. The spherical coordinates (INTᵣ, INT_{θ}, INT_{Φ}) are established according to equations (3)-(5) based on the height H and distance L, determined according to equations (1) and (2), respectively.

INTᵣ=(L²+H²)^{1/2} (3)

INT_{θ}=tan⁻¹(H/L) (4)

INT_{Φ}=Φ₁ (5)

The Cartesian coordinates (INTₓ, INT_{y}, INT_{z}) of the point on the interface INT may be determined from the spherical coordinates (INTᵣ, INT_{θ}, INT_{Φ}) of the point on the interface INT according to equations (6)-(8):

INTₓ=INTᵣ cos (INT_{θ}) cos (INT_{Φ}) (6)

INT_{y}=INTᵣ cos (INT_{θ}) sin (INT_{Φ}) (7)

INT_{z}=INTᵣ sin (INT_{θ}) (8)

FIG. 5C shows the example point on the interface INT relative to the position P3. The azimuth angle Φ₃ and elevation angle θ₃ to the point on the interface INT may be established relative to the point P3 according to equations (9)-(10):

Φ₃=tan⁻¹((INT_{y}−y₃)/(INTₓ−x₃)) (9)

θ₃=tan⁻¹((INT_{z}−z₃)/((INTₓ−x₃)²+(INT_{y}−y₃)²)^{1/2}) (10)

Equations (9) and (10) are suitable for providing, as an output parameter 11, a mapping from one or more points present within both of the acquired images I1, I2 at the same azimuth angle but at different elevation angles θ₁, θ₂, respectively, to corresponding one or more points with azimuth angles Φ₃ and elevation angles θ₃ referenced to the position P3. Determining the azimuth angles Φ₃ and the elevation angles θ₃ referenced to the position P3 enables the solar access 15 or other output parameters 11 to be referenced to the position P3, even though the SOLMETRIC SUNEYE or other measurement system 14 used to acquire the images I1, I2, is typically not positioned at the position P3, and typically does not acquire an image or other measurement with the measurement system 14 positioned at the position P3.

The coordinates of the positions P1, P2, P3 used in equations (1)-(10) are typically user-entered or otherwise provided to the processor 28 as a result of GPS (global positioning system) measurements, dead reckoning, laser range-finding, electronic measurements, physical measurements, or any other suitable methods or techniques for determining or otherwise establishing measurements, coordinates, locations, or physical offsets between the positions P1, P2, P3.

Errors in the determination of the output parameters 11 by the measurement system 14 typically decrease as the vertical, or “z” direction offset, z₂−z₁, between the position P2 and the position P1 increases. Errors in the determination of the output parameters 11 by the measurement system 14 typically decrease as the offset between the position P3 and each of the positions P1, P2 decreases. Accordingly, the vertical offset between the position P2 and P1 is typically designated to be large enough, and the offset of the position P3 from the positions P1, P2 is designated to be small enough so that errors in the output parameters 11 that are attributable to the measurement system 14 are sufficiently small.

The output parameter 11 provided in step 6 of the extrapolation system 10 may also include a determination of solar access 15, a characterization of solar radiation exposure at a designated location and/or orientation. Solar access 15 typically accounts for time-dependent variations in solar radiation exposure that occur at the designated location on daily, seasonal, or other timescales due to the relative motion between the Sun and the Earth. These variations in solar radiation exposure are typically attributable to shading from buildings, trees or other obstructions OBS, variations in atmospheric clearness, or variations in incidence angles of solar radiation at the designated location and orientation where the solar access is determined. Solar access 15 may be expressed by available energy provided by the solar radiation exposure, by percentage of energy of solar radiation exposure, by irradiance in kilowatt-hours or other energy measures, by graphical representations of solar radiation exposure versus time, by measures of insolation such as kilowatt-hours per square meter, by an overlay of the paths of the Sun on the detected skyline 13c, or other relevant skyline, as shown in FIG. 4E, or by other suitable expressions related to, or otherwise associated with, solar radiation exposure. Example representations of solar access 15 are shown in HOME POWER magazine, ISSN1050-2416, October/November 2007, Issue 121, page 89, and by M. K. Dennis, An Automated Solar Shading Calculator, Proceedings of Australian and New Zealand Solar Energy Society, 2002.

The solar access 15 or other output parameter 11 provided in step 6 of the extrapolation system 6 is typically stored in a memory and may be presented on a display or other output device (not shown) that is associated with the measurement system 14.

While the flow diagram of FIG. 1 shows the processing of step 6 after both step 2 and step 4, the processing of step 6 may be distributed in time, or may occur at a variety of time sequences. For example, determining the detected skyline 13a, mapping points in the image I1 to corresponding azimuth angles Φ₁ and elevation angles θ₁, or other processing in step 6 may occur before, during, or after the acquisition of the image I2.

In alternative embodiments of the extrapolation system 10, step 2 and step 4 each include acquiring more than one orientation-referenced image at one or more positions or orientations. For example, the images I1, I2 may each be the result of multiple image acquisitions at the first position P1 and the second position P2, respectively. In another example, the processing of step 6 includes processing three or more orientation-referenced images acquired at corresponding multiple positions to provide the output parameter 11 extrapolated to a position P3 that is remote from each of the three or more positions.

While the embodiments of the present invention have been illustrated in detail, it should be apparent that modifications and adaptations to these embodiments may occur to one skilled in the art without departing from the scope of the present invention as set forth in the following claims.

1. A method, comprising:
acquiring a first orientation-referenced image of a first skyline at a first position;
acquiring a second orientation-referenced image of a second skyline at a second position that has a vertical offset from the first position; and
processing the first orientation-referenced image and the second orientation-referenced image to provide an output parameter extrapolated to a third position having an offset from the first position and the second position, wherein the output parameter includes at least one of a solar access referenced to the third position, a detected skyline referenced to the third position, and a mapping of one or more points that are present in both the first image and the second image, to corresponding one or more points that each have a corresponding azimuth angle and a corresponding elevation angle referenced to the third position.

2. The method of claim 1 wherein the processing includes:
defining an interface between each of one or more obstructions and an open sky at one or more first azimuth angles in the first orientation-referenced image;
determining a first elevation angle to the interface at each of the one or more first azimuth angles in the first orientation-referenced image;
defining the interface between each of the one or more obstructions and the open sky at the one or more first azimuth angles in the second orientation-referenced image;
determining a second elevation angle to the interface at each of the one or more first azimuth angles in the second orientation-referenced image; and
determining a second azimuth angle to the interface and a third elevation angle to the interface, each referenced to the third position, based on the one or more first azimuth angles, the first elevation angle, the second elevation angle, the vertical offset of the second position from the first position, and the offset of the third position from at least one of the first position and the second position.

3. The method of claim 1 wherein processing the first orientation-referenced image includes establishing a first detected skyline referenced to the first position and wherein processing the second orientation-referenced image includes establishing a second detected skyline referenced to the second position.

4. The method of claim 1 wherein the first orientation-referenced image and the second orientation-referenced image are each acquired with a digital camera.

5. The method of claim 4 wherein the digital camera is coupled to a lens having a wide field of view.

6. The method of claim 1 wherein acquiring at least one of the first orientation-referenced image and the second orientation-referenced image includes projecting one or more images onto a contoured surface.

7. The method of claim 6 wherein acquiring the at least one of the first orientation-referenced image and the second orientation-referenced image includes capturing one or more digital images of the one or more images projected onto the contoured surface.

8. The method of claim 1 wherein the mapping includes a detected skyline having multiple points, each point having a corresponding azimuth angle and the corresponding elevation angle referenced to the third position.

9. The method of claim 8 wherein the output parameter extrapolated to the third position includes on the detected skyline, an overlay of paths that the Sun traverses relative to the third position on at least one of a daily and monthly timescale.

10. A method, comprising:
acquiring a first orientation-referenced image at a first position, wherein at least one point in the first orientation-referenced image is mapped to a corresponding first azimuth angle and first elevation angle that are referenced to the first position;
acquiring a second orientation-referenced image at a second position having a vertical offset from the first position, wherein the second orientation-referenced image includes the at least one point in the first orientation-referenced image, wherein the at least one point is mapped to a corresponding second elevation angle and to a corresponding second azimuth angle that is equal to the first azimuth angle, and wherein the second elevation angle and the second azimuth angle are referenced to the second position; and
processing the first orientation-referenced image and the second orientation-referenced image to provide a mapping of the at least one point to a corresponding third azimuth angle and third elevation angle that are referenced to a third position that is offset from the first position and the second position.

11. The method of claim 10 wherein the mapping of the at least one point to the corresponding second azimuth angle and the third elevation angle is used to establish at least one of a solar access referenced to the third position, and a detected skyline referenced to the third position.

12. The method of claim 10 wherein the first orientation-referenced image and the second orientation-referenced image are each acquired with a digital camera.

13. The method of claim 12 wherein the digital camera is coupled to a lens that has a wide field of view.

14. The method of claim 10 wherein acquiring at least one of the first orientation-referenced image and the second orientation-referenced image includes projecting one or more images onto a contoured surface.

15. The method of claim 14 wherein acquiring the at least one of the first orientation-referenced image and the second orientation-referenced image includes capturing one or more digital images of the one or more images projected onto the contoured surface.

16. A method, comprising:
acquiring a first orientation-referenced image of a first skyline with a measurement system located at a first position;
acquiring a second orientation-referenced image of a second skyline with the measurement system located at a second position having a vertical offset from the first position; and
processing the first orientation-referenced image and the second orientation-referenced image with the measurement system to provide an output parameter extrapolated to a third position that is offset from the first position and the second position, wherein the output parameter includes at least one of a solar access referenced to the third position, a detected skyline referenced to the third position, and a mapping of one or more points that are present in both the first image and the second image, to corresponding one or more points that each have a corresponding azimuth angle and a corresponding elevation angle each referenced to the third position.

17. The method of claim 16 wherein the first orientation-referenced image and the second orientation-referenced image are each acquired with a digital camera included in the measurement system.

18. The method of claim 17 wherein the digital camera is coupled to a lens that has a wide field of view.

19. The method of claim 16 wherein acquiring at least one of the first orientation-referenced image and the second orientation-referenced image includes projecting one or more images onto a contoured surface.

20. The method of claim 19 wherein acquiring the at least one of the first orientation-referenced image and the second orientation-referenced image includes capturing one or more digital images of the one or more images projected onto the contoured surface.
